(19) United States
(12) Patent Application Publication
(10) Pub. No.: US 2014/0238352 A1
(43) Pub. Date: Aug. 28, 2014

(54) Fault Diagnostic Strategy For Common Rail Fuel System

(71) Applicant: CATERPILLAR, INC., Peoria, IL (US)

(72) Inventors: Nandagopal Methil, Dunlap, IL (US); Daniel Puckett, Peoria, IL (US)

(73) Assignee: CATERPILLAR, INC., Peoria, IL (US)

(21) Appl. No.: 13/774,141

(22) Filed: Feb. 22, 2013

(51) Int. Cl. F02M 69/50

(52) U.S. Cl. CPC F02M 69/50
USPC 123/456

(57) ABSTRACT

An electronic controller for a common rail fuel system detects a fault when a time sum accumulated error exceeds a threshold. The time sum accumulated error is left unchanged when the operating condition is transient, and either adds to or subtracts from the time sum accumulated error responsive to a rail pressure error and the operating condition being steady state.

### TECHNICAL FIELD

The present disclosure relates generally to common rail fuel systems, and more particularly to a fuel system diagnostic algorithm that differentiates between steady state and transient operating conditions.

### BACKGROUND

Common rail fuel systems, especially those utilized in association with compression ignition engines, typically include a high pressure pump that supplies fuel to, and controls pressure in, a common rail. A plurality of fuel injectors are fluidly connected to the common rail via individual branch passages. In the case of a compression ignition engine, the fuel injectors may be positioned for direct injection of fuel into individual cylinders of the engine. An electronic controller may be in control communication with both the fuel injectors and the high pressure pump. The electronic controller may generate pump control signals to change the output of the pump responsive to an error between a desired rail pressure and an actual rail pressure. The electronic controller may also generate injection control signals to control the timing and quantity of fuel injected from each of the individual fuel injectors in a known manner. Depending upon the engine operating conditions, the desired rail pressure, injection timing and injection quantity may all vary significantly.

Engineers are constantly seeking ways of detecting when a fault has occurred in a common rail fuel system due to leaks, malfunctions, component failures, and other reasons known in the art. Many of these potential faults can be revealed by deviations between an actual rail pressure and a desired rail pressure, but it is often extremely difficult to differentiate between rail pressure errors due to a fuel system fault versus normal rail pressure errors due to proper functioning of the fuel system in a highly dynamic environment. For instance, U.S. Pat. No. 7,835,852 teaches an apparatus for detecting and identifying component failure in a fuel system. Devising a fuel system diagnostic strategy that avoids false positives while accurately detecting faults and doing so without overburdening the electronic controller has remained problematic.

The present disclosure is directed to one or more of the problems set forth above.

### SUMMARY

In one aspect, a common rail fuel system includes a variable output high pressure pump with an outlet fluidly connected to an inlet of a common rail. A plurality of fuel injectors have inlets fluidly connected to the common rail by individual branch passages. An electronic controller is in control communication with the pump and the plurality of fuel injectors, and is configured to execute a fuel system diagnostic algorithm that detects an operating condition that is transient or steady state. The fuel system diagnostic algorithm is configured to add, subtract or leave unchanged a time sum accumulated error responsive to a rail pressure error and the operating condition. The fuel system diagnostic algorithm is also configured to log a fuel system fault responsive to the time sum accumulated error exceeding a threshold magnitude. The fuel system diagnostic algorithm is configured to change the time sum accumulated error more when the operating condition is steady state than when the operating condition is transient.

In another aspect, a method of operating the common rail fuel system includes pumping fuel from the variable output high pressure pump responsive to a pump control signal from the electronic controller. Fuel is injected from a fuel injector responsive to an injection control signal from the electronic controller. A rail pressure error is determined responsive to a difference between a desired rail pressure and an actual rail pressure. An operating condition of the common rail fuel system is determined as transient or steady state responsive to the desired rail pressure. The time sum accumulated error is one of added to, subtracted from or left unchanged each loop time of a processor of the electronic controller. The time sum accumulated error is changed more when the operating condition is steady state than when the operating condition is transient. The time sum accumulated error is compared to a threshold, and a fuel system fault is logged when the time sum accumulated error exceeds the threshold.

### BRIEF DESCRIPTION OF THE DRAWINGS

FIG. 1 is a schematic view of a common rail fuel system according to the present disclosure;

FIG. 2 is logic flow diagram for a fuel system diagnostic algorithm according to another aspect of the present disclosure;

FIG. 3 is graph of desired rail pressure (RP_{D}), actual rail pressure (RP_{A}), high pass filter output (F) and time sum accumulated error (E) versus time, for an example step increase in desired rail pressure according to the present disclosure; and

FIG. 4 is a graph of desired rail pressure, actual rail pressures (RP_{A1}, RP_{A2}) and outputs of two different high pass filters (F₁, F₂) for two different fueling conditions during a step drop in desired rail pressure according to the present disclosure.

### DETAILED DESCRIPTION

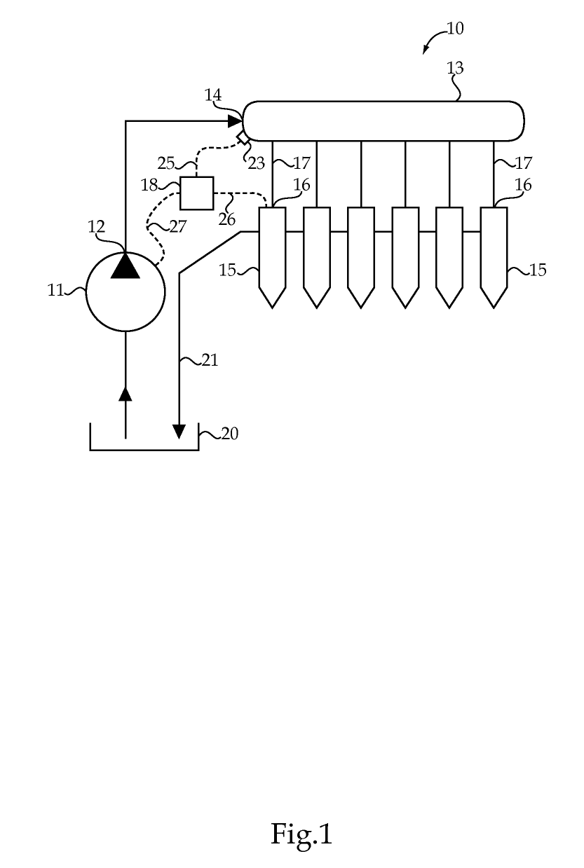

Referring to FIG. 1, a common rail fuel system 10 includes a variable output high pressure pump 11 whose output is controlled by an electronic controller 18 responsive to pump control signals communicated over communication line 27. In one specific example, pump 11 might have its output controlled via an electronically controlled throttle inlet valve in a manner known in the art. Nevertheless, other strategies, such as spill valves and other output control strategies would also fall within the scope of the present disclosure. Variable output high pressure pump 11 draws fuel from a tank 20 and includes an outlet 12 fluidly connected to an inlet 14 of a common rail 13. The electronic controller 18 may monitor the actual rail pressure in common rail 13 by way of a pressure sensor 23 and communication line 25. Thus, variable output high pressure pump 11 delivers fuel to, and controls pressure in, common rail 13 in a manner well known in the art. A plurality of fuel injectors 15 have inlets 16 fluidly connected to the common rail 13 by individual branch passages 17. Fuel injectors 15 may utilize a small portion of the high pressure fuel that is received at inlets 16 to perform a control function, with a majority of the fuel being injected directly into an individual cylinder of an engine (not shown). The small amount of fuel utilized in the control function may be returned to tank 20 via drain line 21. Preferably, fuel injectors 15 are so called “zero leak” fuel injectors in that no fuel is leaked into drain line 21 between injection events. Fuel is injected from each fuel injector 15 responsive to injection control signals from the electronic controller 18 via a communication line 26, only one of which is shown.

Those skilled in the art will appreciate that common rail fuel systems 10 of the type shown in FIG. 1 can suffer from numerous different fault conditions, and most of these fault conditions will exhibit symptoms of rail pressures that are different than a rail pressure if the system were working correctly. For instance, one pumping plunger of the variable output high pressure pump 11 may delivery less fuel than other pump plungers in the same assembly due to some fault condition. In addition, leaks might appear at many locations in the system. In other instances, a valve may become stuck in an open or closed position within one of the fuel injectors 15, resulting in an altered rail pressure trace in the common rail 13. Because rail pressure data is highly dynamic and often noisy, it can often be extremely difficult for a diagnostic algorithm to correctly detect fault conditions without mistakenly identifying fault conditions that do not actually exist. These issues are further compounded by the fact that most common rail fuel systems are designed to operate at different rail pressures depending upon the operating condition of the underlying engine. For instance, the common rail fuel system 10 may be operated at a relatively lower rail pressure during low speed and load conditions, and operate at a much higher rail pressure at rated conditions. In general, the electronic controller will continuously execute a control algorithm to adjust pump control signals so that the actual rail pressure (RP_{A}) is made equal to a desired rail pressure (RP_{D}). For purposes of the present disclosure, a rail pressure error (RP_{E}) is equal to the difference between the actual rail pressure and the desired rail pressure (RP_{E}=RP_{D}−RP_{A}). Those skilled in the art will appreciate that changes in the desired rail pressure may constitute a step change, but the common rail fuel system 10 requires some amount of time in order to adjust the actual rail pressure to a new desired rail pressure level.

One diagnostic strategy that has been considered over the years for common rail fuel systems is to carry an accumulated error variable that is incrementally increased when the rail pressure error is greater than some chosen maximum acceptable rail pressure error, but the accumulated error variable is decremented when the rail pressure error is less than the maximum acceptable error. While such a strategy may be sound when the desired rail pressure is held fixed or slowly changed, large step changes in desired rail pressure and the resulting lag of the system in changing the actual rail pressure will lead to large rail pressure errors immediately following step changes in the desired rail pressure. When the accumulated error variable exceeds some threshold, the system will diagnose a fault condition. However, the large rail pressure errors that exist immediately following a step change in desired rail pressure may lead to false positives by incrementally increasing the accumulated error variable even when the fuel system is performing properly in an effort to drive the actual rail pressure toward the new desired rail pressure. As a result, an accumulated error strategy may prove unreliable in correctly detecting fault conditions and may also incorrectly identify fault conditions when none exists. For instance, in an application where the desired rail pressure is changed often and in large magnitudes, an accumulated error strategy can quickly lead to misdiagnosis of a fault condition. The present disclosure addresses this problem by utilizing an accumulated error strategy, but differentiates between transient and steady state operating conditions for common rail fuel system 10. While the present disclosure teaches the use of an accumulated error variable strategy to detect fuel system faults, in all versions of the present disclosure the fuel system diagnostic algorithm will be configured to change the time sum accumulated error more when the operated condition is steady state than when the operating condition is transient. In other words, a rail pressure error of a given magnitude will result in a larger change to the time sum accumulated error when the operating condition is steady state than when the operating condition is transient. In one preferred embodiment, the time sum accumulated error will be left unchanged when the operating condition is transient, but will be added to or subtracted from depending upon the magnitude of the rail pressure error when the operating condition is deemed to be steady state.

Electronic controller 18 of common rail fuel system 10 is in control communication with the variable output high pressure pump 11 and the plurality of fuel injectors 15, and is configured to execute a fuel system diagnostic algorithm that detects an operating condition that is transient or steady state. Those skilled in the art will appreciate that this aspect of the disclosure can be carried out in a wide variety of ways without departing from the present disclosure. For instance, in a crude strategy, the fuel system diagnostic algorithm might simply deem a transient to begin when a step change in desired rail pressure is commanded, and then proceed for some duration thereafter. For instance, that duration might correspond to an amount of time that the system should be able to bring the rail pressure within a maximum acceptable error after a step change in desired rail pressure. After that duration and until a subsequent step change in desired rail pressure, the system may consider itself to be in an operating condition that is steady state. Other strategies could be used to determine the beginning and/or end of a transient without departing from the present disclosure. On the other end of the spectrum, a more sophisticated version of the present disclosure may require a detailed understanding of an expected system response when the common rail fuel system was behaving properly after a step change and desired rail pressure occurs. For instance, a sophisticated version of the present disclosure might add to or subtract from a time sum accumulated error during a transient responsive to whether the rail pressure error was being reduced slower or faster than the system ought to be able to achieve during the transient. However, one could expect such a strategy to require substantial computing power that may or may not be available for diagnostic purposes in electronic controller 18.

Another strategy for implementing a fuel system diagnostic algorithm according to the present disclosure includes a high pass filter configured for processing a sequence of rail pressure data. For instance, if the rail pressure data were desired rail pressure, application of a high pass filter would normally produce zero output until excited by a step change in desired rail pressure. Thereafter, the output of the high pass filter would decay rapidly. Desired rail pressure data is also free of noise that could unintentionally excite the high pass filter. But the present disclosure does encompass the use of rail pressure data other than desired rail pressure. The present disclosure would teach setting a condition change threshold, and determining the end of a transient and the beginning of steady state when the output of the high pass filter dropped below the condition change threshold. That condition change threshold might correspond to a properly operating system having the ability to bring the rail pressure error to a magnitude smaller than a maximum acceptable error at or before the time at which the high pass filter output passed through the condition change threshold. In other words, the high pass filter could be tuned such that the time sum accumulated error would only be changed after achieving a steady state operating condition and overly large rail pressure errors are indicative of a system fault, whereas the same magnitude rail pressure error during a transient could be expected when the system is operating properly.

A fuel system diagnostic algorithm according to the present disclosure is configured to add, subtract or leave unchanged a time sum accumulated error responsive to the rail pressure error and the operating condition. Finally, the fuel system diagnostic algorithm is configured to log a fuel system fault responsive to the time sum accumulated error exceeding a threshold magnitude, which may be a predetermined value based upon prior testing and understanding of a given common rail fuel system 10. As stated above, the fuel system diagnostic algorithm may be configured to determine the operating condition to be transient or steady state responsive to an output of a high pass filter being respectively greater than or less than a condition change threshold. Those skilled in the art will appreciate that a more conservative condition change threshold will result in ignoring more data, including possibly good data after a step change in desired rail pressure. At an other end of the spectrum, a condition change threshold that is set too large may result in adding to the time sum accumulated error even when common rail fuel system 10 is operating properly. If the condition change threshold is set too small, it may take longer to detect a fuel system fault than might otherwise be possible if the condition change threshold were more closely matched to the expected behavior of the fuel system. For instance, this disclosure would teach an initial setting of a condition change threshold to correspond to a timing at which the common rail fuel system 10 should be able to drive the rail pressure error less than a maximum acceptable error when operating properly. In other versions of the disclosure, the condition change threshold might also be a variable instead of a fixed value. For instance, adjusting the condition change threshold responsive to the magnitude of the desired rail pressure change would also fall within the intended scope of the present disclosure. As stated earlier, a preferred version of the present disclosure would result in a fuel system diagnostic algorithm that is configured to leave the time sum accumulated error unchanged responsive to the operating condition being transient, regardless of the magnitude of the rail pressure error during the transient.

When the fuel system diagnostic algorithm determines that the operating condition is steady state, the time sum accumulated error may be increased by a variable amount, such as proportional to the rail pressure error when the rail pressure error exceeds an acceptable error magnitude. On the otherhand, a fuel system diagnostic algorithm that simply incremented the time sum accumulated error by a fixed quantity when the operating condition was steady state and the rail pressure error exceeded an acceptable error magnitude would also fall within the intended scope of the present disclosure.

The fuel system diagnostic algorithm may be configured to decrease the time sum accumulated error a fixed amount responsive to the operating condition being steady state and the rail pressure error being less than an acceptable error magnitude. Decreasing the time sum accumulated error by a variable amount would also fall within the scope of the present disclosure. For instance, the time sum accumulated error might be decreased by a difference between the maximum acceptable error and the rail pressure error when the rail pressure error is less than the maximum acceptable error. Such a strategy would decrement the time sum accumulated error by a greater quantity when the rail pressure error is small. Those skilled in the art will appreciate that setting the acceptable error magnitude too large may lengthen the time to diagnose a fuel system fault, or may even result in fuel system faults going undetected. On the other hand, if the maximum acceptable error magnitude is set too small, normal fluctuations in the actual rail pressure, such as pressure waves bouncing around in common rail 13, could lead to increasing the time sum accumulated error even when the system is operating properly. A fuel system diagnostic algorithm that decreased the time sum accumulated error a variable amount, such as inversely proportional to the rail pressure error, responsive to the operating condition being steady state and the rail pressure error being less than the maximum acceptable error magnitude would also fall within the scope of the present disclosure.

Those skilled in the art will appreciate that depending upon the expected behavior of a given common rail fuel system 10, more than one high pass filter might be utilized in the application to rail pressure data due to different behaviors of the common rail fuel system 10, such as due to different fueling levels and whether the step change in the desired rail pressure was an increase or a decrease. In the case of the illustrated embodiment, with fuel injectors 15 that are zero leak fuel injectors, and because the variable output high pressure pump 11 can add fuel to, but cannot take fuel out of, common rail 13, the present disclosure teaches the use of a first high pass filter when the desired rail pressure is increased, but a second and different high pass filter when the desired rail pressure takes a step decrease. The reason for this being that when a decrease in rail pressure is commanded, and fueling levels are relatively low, high pressure can remain in the common rail 13 for a significant amount of time until fuel injection events allow the rail pressure to drop. In other words, in a fluid tight system with no separate rail pressure relief valve and zero leak fuel injectors 15, only fuel injection events can reduce pressure in the common rail 13. Those skilled in the art will appreciate that fueling levels following a drop in desired rail pressure can significantly effect how quickly the actual rail pressure can be moved toward the new lower desired rail pressure. Thus, the present disclosure might also consider having two or more different high pass filters responsive to fueling levels immediately following a drop in desired rail pressure responsive to the fueling levels being either high or low immediately following the drop in desired rail pressure. In fact, high pass filters with coefficients that are variables that are changed responsive to fueling levels, and positive or negative changes in desired rail pressure, would also fall within the scope of the present disclosure. In one specific example, it was found that utilizing one high pass filter for increases in the desired rail pressure or decreases in desired rail pressure accompanied by high fueling rates, and a second high pass filter for use when the desired rail pressure decreases with low fueling rates provided satisfactory results, but other common rail fuel systems could vary requiring maybe only high pass filter, two or more high pass filters or maybe even a continuum of different high pass filters in order to perform reliably for a given system.

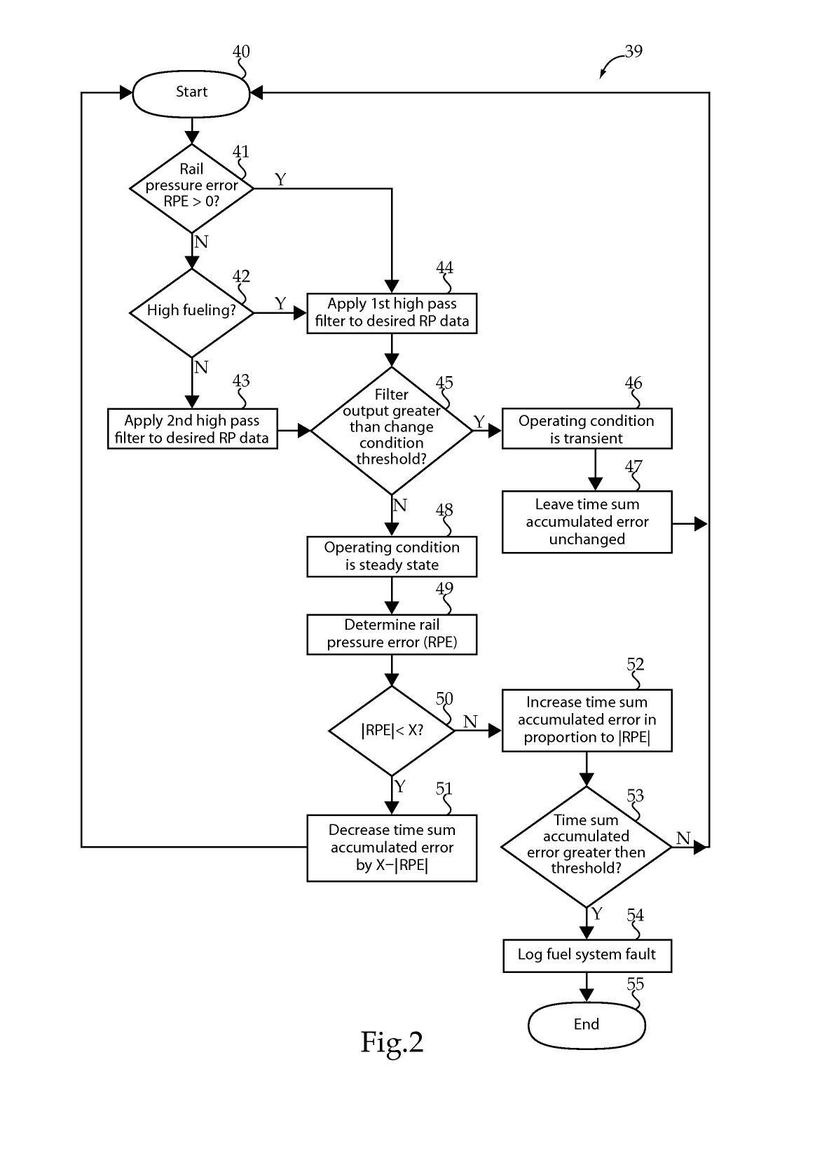

Referring now to FIG. 2, a logic flow diagram for a fuel system diagnostic algorithm 39 according to one aspect of the present disclosure is illustrated. The logic starts at oval 40 and proceeds to query 41 in order to determine whether the rail pressure error is positive. If the rail pressure error is positive (meaning a step increase in desired rail pressure), the logic proceeds to block 44 to apply the first high pass filter to desired rail pressure data. On the otherhand, if the rail pressure error is negative, the logic proceeds to query 42 to determine if fueling is high or low. If fueling is high, the logic again goes to block 44 to apply the first high pass filter. If fueling is low, the logic proceeds to block 43 to apply the second high pass filter to the desired rail pressure data. By rail pressure data, the disclosure means a time sequence of desired rail pressure, such as each loop time through the processor associated with electronic controller 18. After passing through block 43 or 44, the logic advances to query 45 to evaluate whether the output of the high pass filter is greater than a change condition threshold. If the answer is yes, the system advances to block 46 where it is determined that the operating condition is transient. Next, at block 47, the logic determines to leave the time sum accumulated error unchanged and then loop back to start 40. Those skilled in the art will appreciate that the time sum accumulated error may be initialized to zero each time the common rail fuel system 10 is operated, or the time sum accumulated error may be carried forward each time the system 10 is turned off and then operated again without departing from the present disclosure. The algorithm 39 may include some logic (not shown) to maintain the time sum accumulated error zero or positive at all times.

If query 45 returns a negative, the logic advances to block 48 and determines that the operating condition is steady state. Next at block 49, the algorithm determines the rail pressure error, which is calculated by the difference between the desired rail pressure and the actual rail pressure. Next, at query 50, it is determined whether the rail pressure error is less than a maximum acceptable error, which is indicated in the logic flow diagram of FIG. 2 as the letter X. If the rail pressure error magnitude is less than the maximum acceptable error X, the logic advances to block 51 and decreases the time sum accumulated error by a difference between the maximum acceptable error (X) and the rail pressure error (RPE). Thus smaller errors decrement the time sum accumulated error by a greater amount. Thereafter the logic loops back to start 40 to repeat in a subsequent loop through a processor associated with electronic controller 18. If query 50 returns a negative, the logic advances to block 52 and increases the time sum accumulated error in proportion to an absolute value of the rail pressure error. Next, at block 53 the logic determines whether the time sum accumulated error is greater than a threshold. If not, the logic loops back again to repeat at start 40. If query 53 returns a positive result, the logic advances to block 54 to log a fuel system fault. Thereafter, the logic advances to oval 55 and ends. Those skilled in the art appreciate that if the common rail fuel system 10 is operating properly, query 53 should not return a positive result, and block 54 will never be encountered in order to log a fuel system fault.

### INDUSTRIAL APPLICABILITY

The present disclosure finds potential application to common rail fuel systems. The present disclosure finds particular application to common rail fuel systems for use with compression ignition engines. Finally, the present disclosure can also find applicability to fluid tight common rail system, such as those that include so called “zero leak” fuel injectors.

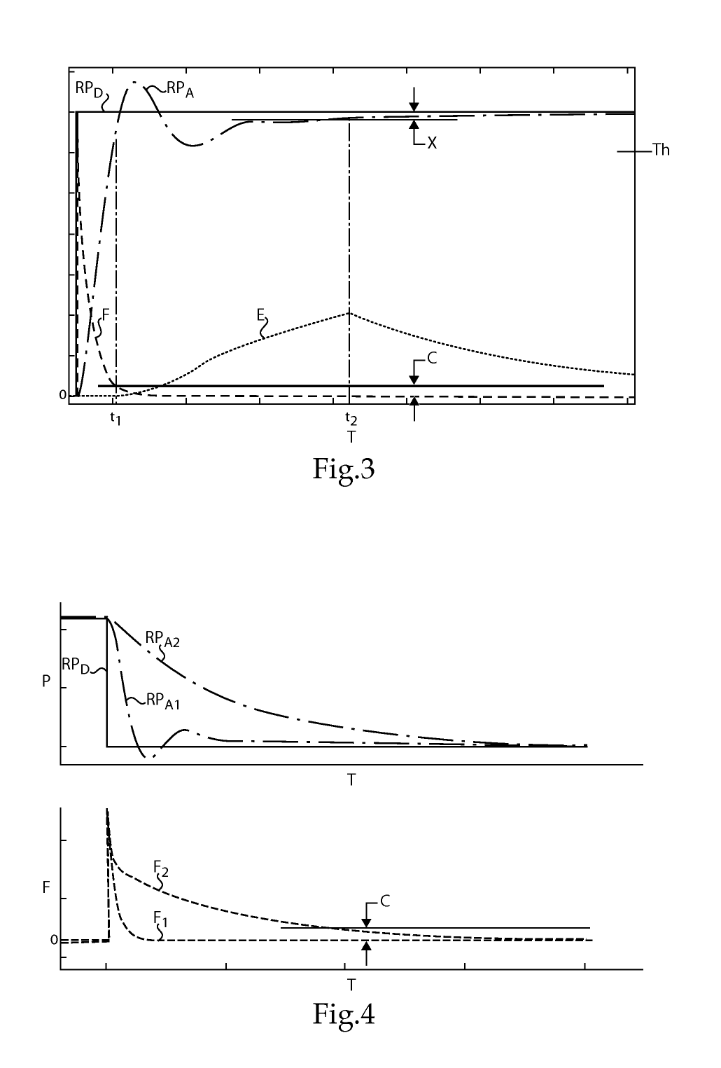

Referring now in addition to FIG. 3, operation of common rail fuel system 10 may include a step change increase in desired rail pressure RP_{D}. When this occurs, a pump control signal to variable output high pressure pump 11 may be changed by electronic controller 18 in order to increase the output from the pump 11. While this is occurring, one or more of the fuel injectors 15 will likely be injecting fuel responsive to injection control signals from electronic controller 18. As shown in FIG. 3, shortly after the step rise in desired rail pressure or RP_{D}, the electronic controller 18 responds by increasing output from variable output high pressure pump 11 to increase the actual rail pressure RP_{A} toward the desired rail pressure. Also shown in FIG. 3 is the output F of the high pass filter that is applied to the desired rail pressure data. As expected, the output F is a maximum coinciding with the step increase in desired rail pressure and decays somewhat rapidly thereafter. Up until time t₁, the fuel system diagnostic algorithm 39 of FIG. 2 will return a positive at query 45 and determine that the operating condition is transient and leave the time sum accumulated error E unchanged. In other words, the rail pressure error during operating condition that is transient is ignored. At time t₁ the output F from the high pass filter becomes less than the condition change threshold C. Thus, after time t₁, the fuel system diagnostic algorithm 39 will determine that the operating condition is steady state by outputting a negative from query 45. Next, the system may determine a rail pressure error RP_{E} responsive to a difference between the desired rail pressure RP_{D} and the actual rail pressure RP_{A}. As stated earlier, the fuel system diagnostic algorithm 40 determines an operating condition of the common rail fuel system 10 as transient or steady state responsive to the desired rail pressure. As long as the output F is greater than the condition change threshold C, the operating condition will be deemed transient. When the output F and the high pass filter is less than the condition change threshold C, the operating condition will be deemed as steady state. Again in reference to FIG. 3, one can see that the time sum accumulated error E begins to build after time t₁ because the actual rail pressure first overshoots the desired rail pressure in a magnitude greater than the maximum acceptable error X. Next, the actual rail pressure drops below the desired rail pressure in a magnitude greater than the maximum acceptable error X. As a result, the time sum accumulated error E continues to build incrementally. Eventually, at time t₂, the actual rail pressure RP_{A} becomes less than the maximum acceptable error X away from the desired rail pressure RP_{D}. The result being that after time t₂, the time sum accumulated error E is decremented according to the fuel system diagnostic algorithm 39 of FIG. 2. In accordance with the present disclosure, the time sum accumulated error E is either zero or always positive with the execution of the fuel system diagnostic algorithm 39 of FIG. 2. Those skilled in the art will appreciate that if there was a problem in common rail fuel system 10, the time sum accumulated error E might continue to build even after time t₂ if the actual rail pressure continued to either oscillate about the desired rail pressure in a magnitude greater than the maximum acceptable error X or otherwise remain greater than the maximum acceptable error X. Eventually, the time sum accumulated error would then build to a threshold Th where the fuel system diagnostic algorithm 40 would determine and log a fuel system fault condition at block 54 by comparing the time sum accumulated error E to the threshold Th.

Those skilled in the art will appreciate that by ignoring rail pressure error data when the operating condition is transient, a time sum accumulated error strategy can be effectively utilized to detect a fault condition in common rail fuel system 10 that is revealed by rail pressure errors greater than a maximum acceptable error magnitude X.

Referring now to FIG. 4, two example high pass filters are illustrated for a step decrease in desired rail pressure (RP_{D}) when the decrease in desired rail pressure is followed by a high fueling response and a low fueling response. Those skilled in the art will appreciate that when little fueling occurs after a drop in desired rail pressure, one could expect the actual rail pressure (RP_{A2}) in common rail 13 to drop relatively slowly. As such, the present disclosure would teach tuning a high pressure filter (F₂) for those conditions to have a slow decay with a curve shape that resembled that actual rail pressure drop that one could expect when common rail fuel system 10 was operating properly. On the otherhand, a different high pass filter (F₁) may be utilized during high fueling conditions immediately following a step drop in desired rail pressure because one could expect the actual rail pressure RP_{A1} to drop relatively quickly toward the new desired rail pressure because a substantial amount of fuel is being injected. In fact, one might utilize the same high pass filter that is utilized during step increases in desired rail pressure during step decreases in desired rail pressure that also include high fueling because the actual rail pressure can be driven toward the desired rail pressure at similar rates. However, if low fueling conditions occur, the logic according to the present disclosure could use a second high pass filter that allows for a slow decay of the output (F₂) from the high pass filter so that relatively large rail pressure errors during the decay are not misinterpreted as indicative of a fault condition in common rail fuel system 10.

Those skilled in the art will appreciate that the present disclosure can be implemented in a wide variety of ways. However, by implementing the present disclosure through the use of one or more high pass filters, very little extra demand can be placed on a processor associated with electronic controller 18, which may have most of its capabilities devoted to controlling timing and quantity of fuel injection events as well as controlling pressure in common rail 13, among other things.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A common rail fuel system comprising:
a variable output high pressure pump;
a common rail with an inlet fluidly connected to an outlet of the pump;
a plurality of fuel injectors with inlets fluidly connected to the common rail by individual branch passages;
an electronic controller in control communication with the pump and the plurality of fuel injectors, and being configured to execute a fuel system diagnostic algorithm that detects an operating condition that is transient or a steady state, configured to add, subtract or leave unchanged a time sum accumulated error responsive to a rail pressure error and the operating condition, and configured to log a fuel system fault responsive to the time sum accumulated error exceeding a threshold magnitude; and
wherein fuel system diagnostic algorithm is configured to change the time sum accumulated error more when the operating condition is steady state than when the operating condition is transient.

2. The common rail fuel system of claim 1 wherein the fuel system diagnostic algorithm includes a high pass filter configured for application to a sequence of rail pressure data.

3. The common rail fuel system of claim 2 wherein the fuel system diagnostic algorithm is configured to determine the operating condition to be transient or steady state responsive to an output of the high pass filter being respectively greater than or less than a condition change threshold.

4. The common rail fuel system of claim 3 wherein the fuel system diagnostic algorithm is configured to leave the time sum accumulated error unchanged responsive to the operating condition being transient.

5. The common rail fuel system of claim 4 wherein the fuel system diagnostic algorithm is configured to increase the time sum accumulated error proportional to a rail pressure error responsive to the operating condition being steady state and the rail pressure error exceeding an acceptable error magnitude.

6. The common rail fuel system of claim 5 wherein the fuel system diagnostic algorithm is configured to decrease the time sum accumulated error a fixed amount responsive to the operating condition being steady state and the rail pressure error being less than the acceptable error magnitude.

7. The common rail fuel system of claim 6 wherein the rail pressure data includes a change in a desired rail pressure.

8. The common rail fuel system of claim 2 wherein the fuel system diagnostic algorithm includes a first high pass filter for an increase to a desired rail pressure, and a second high pass filter for a decrease to the desired rail pressure; and
the fuel injectors are zero leak fuel injectors.

9. The common rail fuel system of claim 2 wherein the fuel system diagnostic algorithm is configured to leave the time sum accumulated error unchanged responsive to the operating condition being transient; and
either adding to or subtracting from the time sum accumulated error responsive to the operating condition being steady state and a magnitude of a rail pressure error.

10. The common rail fuel system of claim 9 wherein the fuel system diagnostic algorithm includes a first high pass filter for an increase to a desired rail pressure, and a second high pass filter for a decrease to the desired rail pressure; and
the fuel injectors are zero leak fuel injectors.

11. A method of operating a common rail fuel system that includes a variable output high pressure pump, a common rail with an inlet fluidly connected to an outlet of the pump, a plurality of fuel injectors with inlets fluidly connected to the common rail by individual branch passages, and an electronic controller in control communication with the pump and the plurality of fuel injectors, and being configured to execute a fuel system diagnostic algorithm that detects an operating condition that is transient or a steady state, configured to add, subtract or leave unchanged a time sum accumulated error responsive to a rail pressure error and the operating condition, and configured to log a fuel system fault responsive to the time sum accumulated error exceeding a threshold magnitude, comprising the steps of:
pumping fuel from the variable output high pressure pump responsive to a pump control signal from the electronic controller;
injecting fuel from a fuel injector responsive to an injection control signal from the electronic controller;
determining a rail pressure error responsive to a difference between a desired rail pressure and an actual rail pressure;
determining an operating condition of the common rail fuel system as transient or steady state responsive to the desired rail pressure;
doing one of adding to, subtracting from or leaving unchanged a time sum accumulated error each loop time of a processor of the electronic controller;
changing the time sum accumulated error more when the operating condition is steady state than when the operating condition is transient; and
comparing the time sum accumulated error to a threshold; and
logging a fuel system fault when the time sum accumulated error exceeds the threshold.

12. The method of claim 11 including a step of processing rail pressure data through a high pass filter.

13. The method of claim 12 wherein the determined operating condition is transient or steady state responsive to an output of the high pass filter being respectively greater than or less than a condition change threshold.

14. The method of claim 13 wherein the time sum accumulated error is left unchanged responsive to the operating condition being transient.

15. The method of claim 14 wherein the time sum accumulated error is increased proportional to a rail pressure error responsive to the operating condition being steady state and the rail pressure error exceeding an acceptable error magnitude.

16. The method of claim 15 wherein the time sum accumulated error is decreased a fixed amount responsive to the operating condition being steady state and the rail pressure error being less than the acceptable error magnitude.

17. The method of claim 16 wherein the rail pressure data includes a step change in a desired rail pressure.

18. The method of claim 12 wherein the rail pressure data is processed through a first high pass filter for a step increase in desired rail pressure, and a second high pass filter for a step decrease in the desired rail pressure; and
leaking no fuel from the fuel injectors between injection events.

19. The method of claim 12 wherein the time sum accumulated error is left unchanged responsive to the operating condition being transient; and
the time sum accumulated error is either added to or subtracted from responsive to the operating condition being steady state and a magnitude of the rail pressure error.

20. The method of claim 19 wherein the rail pressure data is processed through a first high pass filter for a step increase in desired rail pressure, and a second high pass filter for a step decrease in the desired rail pressure; and
leaking no fuel from the fuel injectors between injection events.
